(19) United States
(12) Patent Application Publication
(10) Pub. No.: US 2025/0277363 A1
(43) Pub. Date: Sep. 4, 2025

(54) CUBOID CONSTRUCTION ELEMENT, METHOD FOR MANUFACTURING A CONSTRUCTION ELEMENT, AND SYSTEM COMPRISING TWO CUBOID CONSTRUCTION ELEMENTS

(71) Applicant: Johann BIRKLE, Camedo (CH)

(72) Inventor: Johann BIRKLE, Camedo (CH)

(21) Appl. No.: 18/858,432

(22) PCT Filed: Mar. 31, 2023
(86) PCT No.: PCT/EP2023/058430

§ 371 Date: Oct. 21, 2024

(30) Foreign Application Priority Data
Apr. 21, 2022 (CH) CH000461/2022

(51) Int. Cl. E04B 2/50

(52) U.S. Cl. CPC E04B 2/50

(57) ABSTRACT

The invention relates to a substantially cuboid construction element (101, 102) made of plastic for use as a construction material. The construction element (101, 102) comprises four side surfaces (21, 22, 23, 24) which are vertically oriented when the construction element (101, 102) is in an installation position (11). The side surfaces (21, 22, 23, 24) each have at least one receiving structure (3). The upper side (4) of the construction element (101, 102), in the installation position (11), has at least one male connecting element or one female connecting element, and a lower side (5) of the construction element has at least the other male connecting element (6) or female connecting element (7). The male connecting element (6) and female connecting element (7) are shaped so as to be complementary to one another.

The invention relates to a box-shaped component, a method for manufacturing a substantially box-shaped component, and a system comprising at least two box-shaped components and a connecting element according to the independent claims.

The construction of buildings often requires specialist knowledge, meaning that the cost of services often exceeds the cost of materials many times over. Private individuals can generally only play a minor role in the construction of buildings, as the arrangement and alignment of building materials, especially load-bearing structures such as walls and foundations, is only possible with a great deal of labor and incorrect arrangements are difficult to correct. In addition, construction projects using conventional building materials often require a wide range of equipment to which private individuals do not have access, or which at least entail substantial financial costs.

Repair work and/or extension projects are often associated with considerable expense and/or cannot be carried out flexibly according to your own design ideas.

In addition, the cost of building materials is often very high, preventing affordable housing from being accessible to a large number of people.

Various elements for use as building materials are known in the state of the art. However, there is generally a lack of a simple, intuitive, user-friendly and quick method of use for arranging the components relative to each other and fixing the components, in particular without additional equipment.

For example, US 2004/000114 A1 shows modular components that have passages so that the components can be fixed relative to each other. However, the use of these components is complicated and requires concrete and structural steel for fixing.

It is the task of the present invention to overcome these and other disadvantages of the prior art. In particular, a simple and cost-effective component for use as a building material is to be provided.

This task is solved by a component defined in the independent claims, a method for manufacturing a component, and a system. Further embodiments result from the dependent claims.

A substantially box-shaped component according to the invention, comprising at least partially plastic and four side faces oriented vertically in an installation position. The side faces each have at least one receiving structure. In the installation position, an upper side of the component has a male connecting element and a lower side has a female connecting element or the upper side has a female connecting element and the lower side has a male connecting element.

The male connecting element and female connecting element are shaped to complement each other.

Shaped complementary to each other defines in this context an at least partially form-fitting connection possibility of the elements shaped complementary to each other.

The component can consist of or include thermosets or thermoplastics.

In particular, the component may consist of or comprise thermosetting plastics such as cured synthetic resins cured prepolymers.

In particular, the component may consist of or comprise thermoplastics such as polyolefins, in particular preferably polypropylene and/or polyethylene, polymethyl methacrylate, or polystyrene.

The component can also consist of 50%, preferably 90%, in particular preferably essentially completely, of plastic.

The component can also include fillers and/or colorants. Inexpensive fillers, such as quartz sand, can reduce the cost of the components. Dyes can be adapted to the aesthetic preferences of the user or used to mark different components in order to improve recognizability.

The component can be made from at least partially recycled plastic to reduce costs.

The component can include fire protection, thermal insulation and/or noise insulation materials. The trapped air inside the component also has an insulating effect. In addition, insulating material can be attached outside or inside the component. This has the advantage that the additional step of attaching insulation can be avoided.

Alternatively, separate insulating materials can be attached to the component, preferably through a casing or between a casing of the component.

The component can be used for the construction of walls of buildings.

A component can have a horizontal recess in the installation position to accommodate a support device, in particular beams. The horizontal recess can run through the component completely or only partially. This means that components on two opposite sides of a wall can accommodate a support device that can be used, for example, to support a false floor or a ceiling, in particular false floor elements.

The at least one male connecting element and the female connecting element can be aligned in the longitudinal direction perpendicular to the lower side and/or upper side. In particular, the at least one male connecting element can be arranged on the upper side in an installation position of the component. Due to such alignment and arrangement, the components can be easily stacked without slipping and can also be transported in a space-saving manner.

The male and female connecting element can have a round, oval, polygonal, in particular regular polygonal shape in cross-section.

An oval, polygonal or regular polygonal shape of the connecting elements has the advantage that two different components cannot be rotated when the male and female connecting elements of two components are connected. This makes it easier to arrange the components in a straight line one above the other.

The upper side and/or lower side can each have one to ten connecting elements, in particular one to ten male or one to ten female connecting elements.

The component can be mirror-symmetrical along one or two planes. Such mirror symmetry simplifies the arrangement of the components in relation to each other for the user.

The receiving structure can extend continuously in a straight line from an upper side of the component to a lower side of the component. Preferably, the receiving structure extends essentially in a vertical direction in the installation position of the component.

The receiving structure may have at least one recess extending over part or all of the side face. The cross-section of the recess can include an undercut.

The cross-section of the recess can be L-shaped, T-shaped, C-shaped, Z-shaped, dovetail-shaped, trapezoidal, knob-shaped, oval and/or curved. Such a cross-section enables two components to be connected, preferably by essentially positive connections, by inserting a connecting element, in particular a connecting bar. Such a connection can counteract a force acting perpendicular to the connected side faces, which pushes the two components apart.

The receiving structure can have at least two recesses, in particular three, four, five or six recesses. The longitudinal axes of the recesses can be parallel and spatially spaced apart.

The undercuts of the recesses can run in cross-section in the direction of the adjacent recess. Such undercuts allow the recesses to be spaced further apart on the side face. The distance between two recesses can be between 2 cm and 30 cm, in particular 20 cm. A greater distance between the recesses means that the transverse forces acting on components or connecting elements can be better compensated.

The receiving structures can have a recess which has a straight longitudinal axis and which runs partially or completely parallel to the recesses in the longitudinal direction. This recess can be suitable for receiving a connecting bar of an attachment element, so that the connection between two components can be additionally reinforced. The receiving structure can have a recess in addition to or as an alternative to the recess. The recess can be designed to accommodate a connecting bar and/or a cable.

A further task of the present invention is to provide a component which allows cables to be laid in the wall and at the same time provides an aesthetically pleasing, aligned wall surface.

The box-shaped component can be a component as described above. The component comprises four side faces aligned vertically in an installation position of the component.

At least two, preferably three or four, of the side faces each have a receiving structure.

At least two, preferably three or four, of the receiving structures comprise at least one recess for receiving at least one attachment element for connection to an adjacent component or a wall panel.

At least one of the receiving structures, preferably a receiving structure with a recess for receiving at least one attachment element, has a recess for receiving a cable. The recess is arranged, preferably centrally, in such a way that recesses of components stacked on top of one another are aligned, so that a continuous receptacle for a cable is formed.

The recess extends from one side face to an opposite side face. Such a recess can be particularly advantageous in combination with the embodiments explained above with receiving structures for receiving at least one attachment element on all four side faces. It is understood that such recesses for receiving a cable can also be advantageous in connection with other types of connection between individual components.

In the installation position, an upper side of the component can have a male connecting element and a lower side can have a female connecting element, or the upper side can have a female connecting element and the lower side can have a male connecting element.

The male connecting element and female connecting element can be shaped to complement each other.

The upper side of the component may comprise a step, preferably a step between at least one of the side faces and the upper side, so that components arranged one above the other form an at least partially enclosed cavity. The cavity is adjacent to a recess, preferably at least two recesses.

The step can extend at least partially or completely along a circumferential direction of the component. An arrangement of the step in the circumferential direction enables electrical cables to be routed in a horizontal direction in an installation position of the component.

The step can extend along an outer edge, formed by the upper side with the side faces of the component. This makes the step easily accessible and an attachment element, preferably with at least one connecting latch, can be easily attached.

The component may comprise a passage having a longitudinal axis which is aligned rectilinearly, preferably vertically, in the installation position and extends from the upper side to the lower side.

Such a passage offers the advantage that a water pipe, an electricity line, a radiator and/or a support structure can be placed in the passage.

A vertical passage in one installation position offers the advantage that several components arranged one above the other can form a continuous passage.

The cross-section of the passage can be circular, elliptical or polygonal, in particular regular polygonal.

The passage has a maximum diameter of 3 cm to 15 cm or essentially 30%, in particular 20%, of the maximum side length.

The passage can form the female connecting element.

The passage can extend through the protruding area of the male connecting element.

When connecting the female and male connecting elements of two components with one passage each, an aligned connection of the passages to each other can be ensured.

The longitudinal axis of the passage can run through a mirror axis of the component, preferably through the geometric center of gravity of the component. This means that a user has to pay less attention to the orientation of the passage when connecting components.

The component can be mounted in the installation position
a height, measured in vertical direction, in the range of 10 cm to 40 cm, in particular 15 cm to 25 cm;
a width, measured from the farthest side faces, in the range from 10 cm to 80 cm, in particular 15 cm to 50 cm;
have a depth, measured in a direction perpendicular to the height and width, in the range from 10 cm to 40 cm, in particular from 15 cm to 25 cm.

The height results from the vertical height of the component, excluding the height of the male connecting element.

The essentially box-shaped component can be produced by injection moulding.

A further aspect of the invention relates to a system comprising at least two components, in particular components as described above, and a connecting element for substantially positive connection to a receiving structure of one of the components and connection of two receiving structures of the components.

The other elements of the system may consist of or comprise the same materials as a component described above.

The attachment element can comprise a head section with a central web that has at least one lateral flange, preferably two lateral flanges.

The two lateral flanges can be arranged on opposite sides of the head section.

The head area of the attachment element can be at least partially rectangular, round, oval, dovetail-shaped, trapezoidal, double-T or I-shaped.

The head area of the attachment element in the installation position can have essentially twice the horizontal width of the step of the component, preferably along the entire longitudinal axis of the head area. Such a head area is advantageous, as the head area can thus be positively received by the steps of two components in order to fix two components relative to each other.

The center web can have a smaller width than the at least one lateral flange, in particular both lateral flanges.

The lateral flange can be materially connected to at least one connecting bar. A first lateral flange can be materially connected to a first connecting bar and a second flange can be materially connected to a second connecting bar. The at least one connecting bar can be inserted substantially positively into at least part of the receiving structures of two components at the same time in order to connect the two components.

At least two, preferably three, connecting bars can be materially connected by the head area so that they can be moved together, in particular can be inserted into the receiving structure by a translational movement. Thus, several recesses and/or recesses of a receiving structure of one component can be connected to another receiving structure of another component by a single attachment element.

The head area can be shorter in the horizontal direction than a horizontal side of the component. Such a head area has the advantage that power cables and heaters can still be attached horizontally in the step of the component from one side face to an opposite side face despite the attachment element being attached.

The connecting bolts can be fitted in the outermost area of the side flange.

The center bar can also have a connecting bar for insertion into the recess of the receiving structure of the component.

The connecting bars can run at least partially parallel to each other. This has the advantage that several connecting bars can be inserted into the recess(es) and/or recesses of two components by a single translational movement in order to connect them.

The cross-section of the connecting bar can have a complementary shape to two adjacent recesses, in particular a double-L, double-T, double-C, double-Z, dovetail-shaped, trapezoidal, double-knob-shaped, double-oval or curved shape.

A dovetail-shaped connecting bar is more rigid and enables two components to be fixed in a stable position relative to each other with a single connecting bar.

Two connecting latches, in particular connecting latches of an L-shaped form, on the other hand, enable a more flexible connection of components. Even if a connecting latch is damaged or defective, such connecting latches can still be used to connect two components.

The steps, recesses and recesses of the components can essentially accommodate the attachment element with a positive fit. This simplifies the connection of two components with an attachment element and also minimizes the relative movement of the components to each other.

The system may comprise at least one first box-shaped component and at least one second box-shaped component. The first component may be substantially half the size, one third the size, or one quarter the size of the second component. The first component can be essentially cube-shaped.

This has the advantage that rows of components arranged on top of each other can be staggered and still be arranged laterally at corners, door frames and windows. A staggered arrangement of the components ensures greater stability.

The system may comprise a wall panel and the wall panel may have a first connection area on a first side face. The connection area can protrude from the side face and can be positively connectable to the receiving structure of the component.

The connection area can be shaped in such a way that the connection area can be connected to the recess of the receiving structure. However, the recess can remain free of blockages when the wall panel is connected to the receiving structure, so that electrical and/or water pipes can be routed through the recess while the wall panel is connected.

The wall panel can also protrude laterally over at least one side face of the component, so that two wall panels arranged at an angle to each other form a protruding corner.

A laterally protruding area of the wall panel can be mitered so that the corner joint can be arranged at an angle.

The first connection area of the wall panel can have a substantially complementary shape to the at least one recess and/or a depression, in particular L-shaped, T-shaped, C-shaped, Z-shaped, dovetail-shaped, knob-shaped, oval, and/or curved. This has the advantage that the receiving structure is suitable both for connecting adjacent components by means of attachment elements and for attaching wall panels.

The receiving structures, in particular the recesses and recesses, of components lying one above the other can be arranged in such a way that they run along a common longitudinal axis. Such an arrangement has the advantage that elements, such as a casing element, can be moved from an upper end of a receiving structure of a plurality of superimposed components to a lower end of the plurality of superimposed components along the receiving structure of the components.

The wall panels can be shaped in such a way that the connection area can only be attached to the at least one recess and at least one recess or recess of the component is not filled. This has the advantage that cables can be laid on a side face of the component and the wall panel can then be attached above it.

The connection area of the wall panel optionally does not extend over the entire extent of the component or has interruptions. This offers the advantage that cables, lines or wall heaters can be routed laterally to neighboring components in addition to the longitudinal axis of a recess. In particular, the cables, lines or wall heaters can be routed through a cavity created by the step of the component when stacking components on top of each other.

The wall panel can also have recesses to accommodate cables, pipes or wall heating.

The wall panel may have widened areas comprising noise or heat insulating material. Such wall panels have the advantage that insulation can be easily attached, replaced and, in particular, easily retrofitted or upgraded.

The opposite second side face of the wall panel can form a substantially flat surface. The wall panel can then be used as a cover for the component.

The system may include a separate casing element. The wall panel may have a second connection area for attaching the casing element on a second side face opposite the first connection area.

The longitudinal axis of the second connection area can extend partially or completely in a horizontal direction in an installation position of the wall panel. In an installation position of the wall panel, the second connection area can be open at the top, in particular forming an at least partially hook-shaped cross-section. Such an arrangement has the advantage that casing elements can be fixed relative to the wall panel by gravity alone. In addition, the casing elements can thus be attached, as the casing elements can be inserted vertically from above into the second connection area.

The wall panel and/or casing element can have essentially the same periphery as a side face of the component.

However, a periphery of the wall panels and/or casing elements can also extend over the side face of several components.

The system can comprise a corner casing element. The corner casing element can have at least one connection area, so that the corner casing element can be connected to at least two receiving structures of adjacent side faces of a component. Alternatively, the connection area of the corner casing element can be connected to two second connection areas of two different wall panels.

Such corner casing elements have the advantage that the wall cladding ends at the corners and is therefore aesthetically pleasing for the user.

An inner side face or outer side face of the corner casing element can essentially correspond to a whole or half side face of the component. This makes it easier to form the wall with aligned casing elements, as no further casing elements of different sizes need to be used.

The system can comprise an essentially box-shaped foundation element. The foundation element can have at least one recessed and/or protruding receiving region on an upper side in an installation position, preferably two, four, six or eight recessed and/or protruding receiving regions for connection to a base element or component. On the four side faces, the foundation element can have male and/or female connecting elements which are shaped to complement each other.

The foundation element can form a rectangular or square surface. The surface can have dimensions that correspond to the lower side of the component. This has the advantage that the foundation element can be used modularly with the component.

The foundation element can have only male or only female connecting elements on one side face. This makes it easier to align the connecting elements for connection.

The foundation element can have two or more male and/or female connecting elements per side face.

The foundation element can have only male connecting elements on one side face and only female connecting elements on an opposite side face. Such an arrangement has the advantage that a user can more easily fix the foundation elements relative to each other.

The male and female connecting elements can be arranged in one installation position only in a head area of the four side faces. This has the advantage that the foundation elements only need to be raised slightly in order to connect the corresponding male and female connecting elements to each other by lowering them vertically.

The foundation element can have a cavity. The cavity can be connected to the upper side of the foundation element by a passage. This has the advantage that the cavity is accessible from above when a large number of foundation elements are connected to form a surface.

The passage may also be shaped to receive an elongate reinforcement, in particular a steel strut or tube or, for example, a plastic strut or tube. This allows the reinforcement to be anchored in the foundation while improving the structural integrity of the system, which can form a wall, for example.

The foundation element can be open on a lower side in an installation position, or enclose the cavity on the lower side. If the foundation element is open at the bottom, a surface on which the foundation element is placed can form a lower side of the cavity. Such a cavity can save foundation element material.

A box-shaped foundation element of the system can alternatively have at least one recessed and/or protruding receiving region on an upper side in an installation position, preferably two, four, six or eight recessed and/or protruding receiving regions, for connection to a base element or the component. The four side faces of the foundation element can each have at least one undercut.

The undercut of the foundation element can extend from the upper side of the foundation element to a lower side of the foundation element. In particular, the undercut extends perpendicular to the foundation element in the installation position. The undercut can have an essentially constant cross-sectional extent over the entire extent of the undercut.

The foundation element can be closed on at least one side adjacent to the lower side. This means that the foundation formed from a large number of foundation elements can be closed to the outside so that it can be filled with filling material.

The cavity can have at least one lateral opening on one side adjacent to the lower side, so that a connection to cavities of neighboring foundation elements can be formed. Such a connection has the advantage that filling material such as concrete can be filled in one cavity and also distributed in the other cavities of other foundation elements.

The system can include a closure element for closing at least one side opening of the foundation element.

Preferably, the foundation element can have lateral openings on two, three or four sides adjacent to the lower side in the installation position to the cavity of the foundation element.

Alternatively or additionally, the system can comprise a foundation connecting element for connecting two foundation elements by engaging in the undercuts.

The at least one lateral opening of the foundation element can be at least partially formed by the undercut.

Perpendicular to the surface of the foundation element in the installation position of the foundation element, the closing element can be inserted into the lateral opening, in particular into the undercut. The closure element can be shaped complementary to the undercut so that the closure element can close a lateral opening when the closure element is inserted vertically into the undercut in the installation position of the foundation element. A length of the closing element preferably corresponds to at least one extension of the undercut or at least the lateral opening if this is formed by only a part of the undercut.

The closure element makes it possible to adjust the size of a foundation that is laid using a large number of foundation elements. In addition, a user does not have to use foundation elements with different numbers of side openings to enclose a foundation area for filling, but all foundation elements can have more than three, in particular four, side openings.

The system comprising the foundation element may comprise two foundation elements. The foundation connecting element can be shaped for essentially form-fitting attachment in two undercuts of two foundation elements in order to connect them to one another. The foundation connecting element preferably does not extend along the entire height of the foundation connecting element in the installation position. This means that a lateral opening formed by only part of the undercut can remain open even though the foundation connecting element has been inserted. The foundation connecting element can be shaped to correspond to two adjacent undercuts of two foundation elements.

In the installation position, a passage of the foundation element can extend from the upper side through the receiving regions to the lower side of the foundation element.

The system can comprise an intermediate floor element. In an installation position, the intermediate base element has at least one attachment area on each of four vertical side faces for attachment to the receiving structure of a component. The attachment area can also be designed for attachment with an adjacent attachment area.

The intermediate floor element can have a cavity for pipes, in particular underfloor heating. Alternatively, a separate intermediate floor support element can have such a cavity.

The intermediate floor element and/or the intermediate floor support element can run continuously from one side of the wall formed by components to an opposite side of the wall.

The intermediate shelf elements and intermediate shelf support elements can be arranged in a horizontal plane at an angle relative to each other, in particular at a right angle. This arrangement increases the stability of the false floor.

The intermediate floor element and/or intermediate floor support element can rest on the casing elements and/or wall panels of the system, which are attached to the components of a wall. Thus, the intermediate floor element and/or the intermediate floor support element can be supported by the casing elements and/or wall panels.

The system can comprise a base element. In an installation position, the base element can have at least one connecting element on a lower side, which is shaped complementary to the at least one protruding or recessed area of the foundation element.

On the upper side of the base element in an installation position, the base element can have at least one recess and a substantially horizontal surface. The recess may be suitable for receiving a component or a floor covering element.

Alternatively, the base element can have at least one protruding area on the upper side.

The protruding or recessed area can be arranged vertically above the connecting element of the base element in one installation position. The recessed area or the protruding area can be shaped complementary to a male connecting element or female connecting element of the component.

The base element can comprise two, four, six or eight protruding or recessed areas. The protruding and/or recessed areas can be arranged mirror-symmetrically on one axis, preferably two axes, on the base element. The upper side of the base element can accommodate at least one floor covering element, which preferably has the same periphery as part or all of the upper side of the base element. The floor covering elements can also have multiples of the extent of the periphery of the base element, so that the amount of work required to attach them is reduced.

A vertically extending side face of the base element in the installation position can have an upwardly extending and protruding area. There may be two protruding areas on opposite sides of the base element. This protruding area can be fixed by a wall panel or a gable element.

The base element can have a passage extending from the upper side of the base element to the lower side of the base element. The passage can extend through the upwardly protruding or recessed area on the upper side and, in particular, through the connecting element located on the lower side.

The passages of the component, the foundation element and, in particular, the base element of the system can be arranged directly above one another in the respective installation position to form a continuous cavity. The elongated reinforcement can be arranged in the passage of the component, the foundation element and/or the base element, in particular in the entire continuous cavity.

The system can also include the elongated reinforcement. The elongate reinforcement may be insertable into at least two components stacked on top of each other in the passages in the installation position. The elongated reinforcement can have a length of at least 1 m, in particular at least 1.5 m, preferably at least 2 m.

This allows the reinforcement to stabilize the wall and preferably to be anchored in the ground and/or the foundation that can be poured with filler.

The reinforcement can have a channel along a longitudinal extension of the reinforcement, which preferably extends over the entire length of the reinforcement and preferably has two openings at two longitudinal ends of the reinforcement. On the one hand, this makes it possible to save material and, on the other hand, water pipes, electrical cables or radiators can be installed in the reinforcement.

An alternative embodiment of the component can have two receiving structures as described above on the two opposite vertical side faces in one installation position. On the other two opposite vertical side faces of the component, on the other hand, the component has connection areas which are formed analogously to the connection areas of the wall panel.

Otherwise, such a component is shaped as described above. Such a component allows the casing elements to be attached directly to the component without a wall panel.

At least one side face of the component in an installation position can have a projection extending downwards or upwards.

Such an attachment allows components mounted on top of each other to be more strongly connected to each other. The attachment can extend continuously or partially between two opposing side faces of the component.

The components and components of the systems described above can each have a base area that is an integer subset of 120×80 cm² or an integer multiple of 120×80 cm². This has the advantage that the components can be easily transported on pallets of this size.

The invention will now be described with reference to certain embodiments and the accompanying figures, which show:

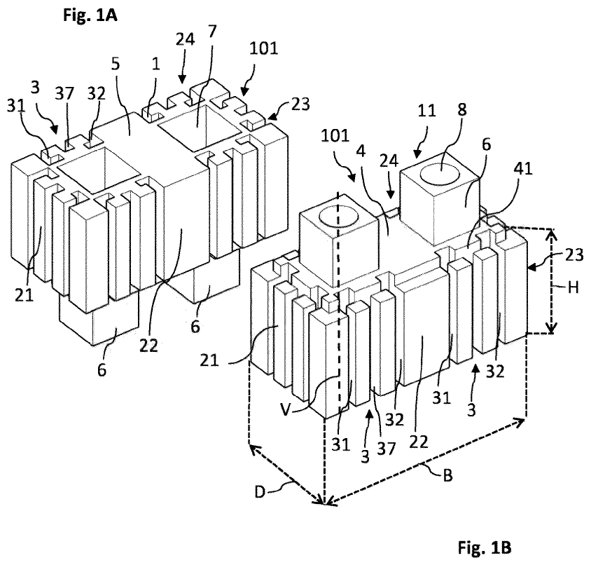

FIGS. 1A and 1B: Perspective view from below and above of an embodiment of a component,

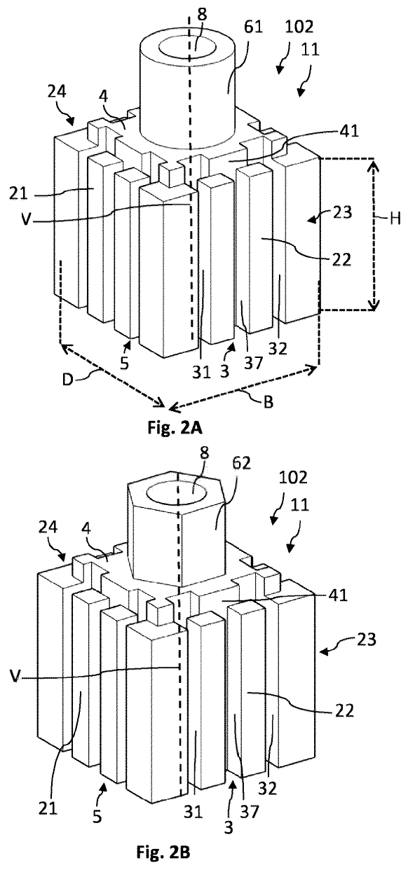

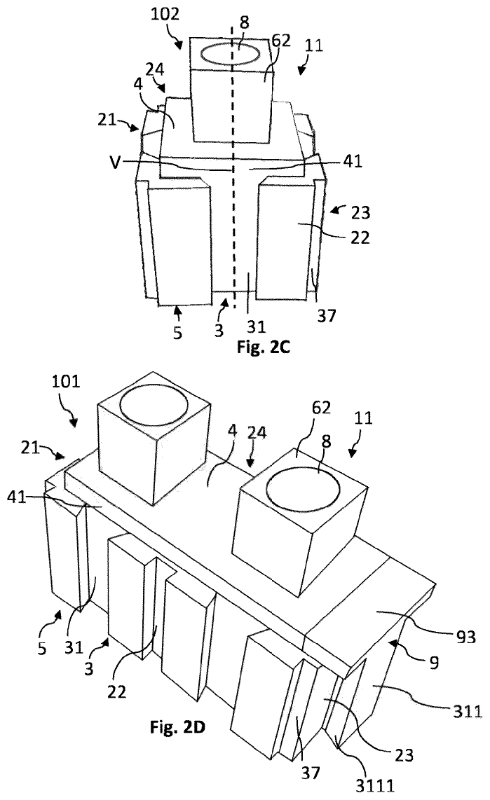

FIGS. 2A to 2C: Perspective view from above of three alternative embodiments of the component, FIG. 2D: Perspective view from above of a fourth embodiment of the component connected to an attachment element,

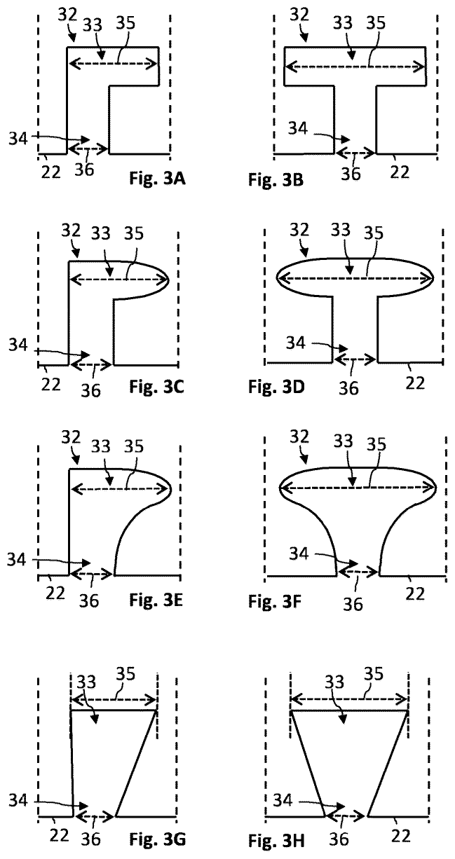

FIGS. 3A to 3H: Cross-sections of various embodiments of recesses in a component,

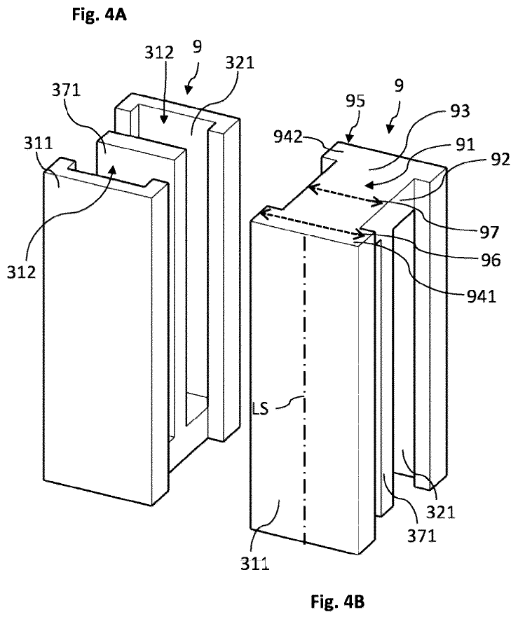

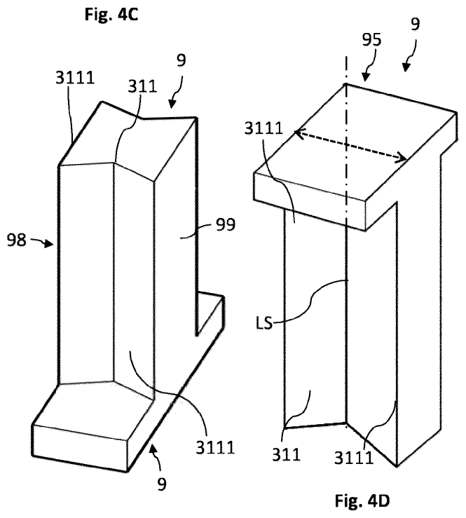

FIGS. 4A and 4B: Perspective view from below and above of a first version of an attachment element,

FIGS. 4C and 4D: Perspective view from below and from above of a second version of an attachment element,

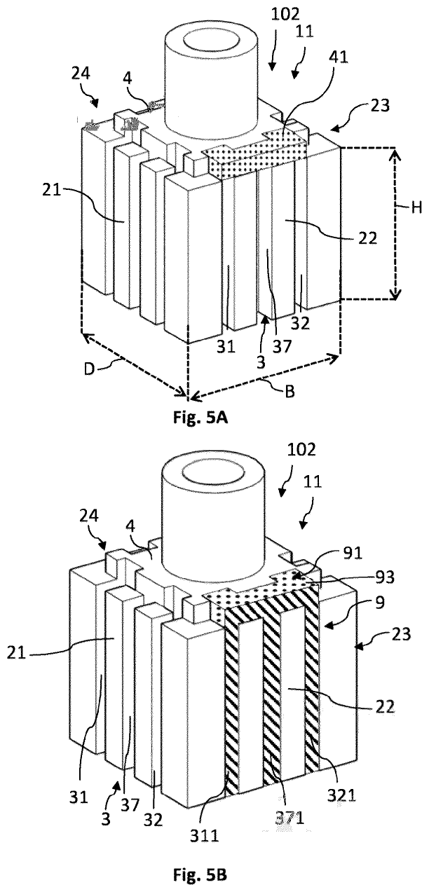

FIG. 5A: Perspective view of a version of the component with a step,

FIG. 5B: Perspective view of a version of the component according to FIG. 5A with an attached attachment element in longitudinal section,

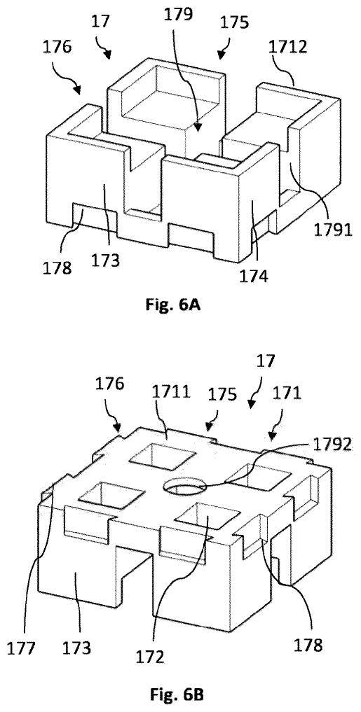

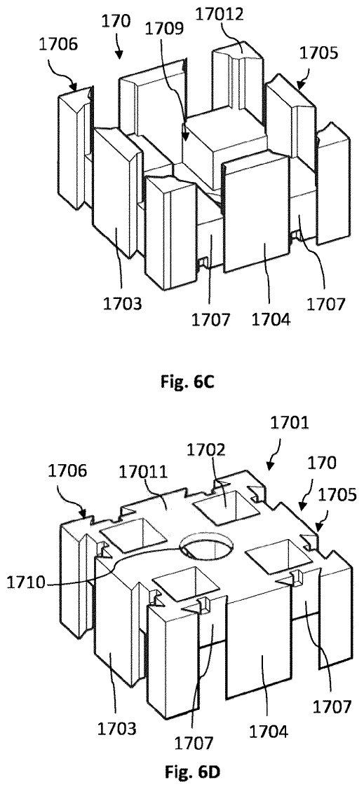

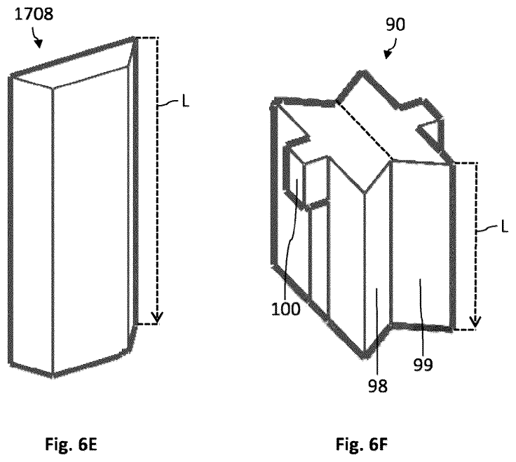

FIGS. 6A and 6B: Perspective view from below and from above of an embodiment of a foundation element,

FIGS. 6C and 6D: Perspective view from below and from above of an embodiment of the foundation element,

FIG. 6E: Perspective view of an embodiment of a closure element for closing a lateral opening of the foundation element according to FIGS. 6C and 6D,

FIG. 6F: Perspective view of an embodiment of a foundation connecting element for the form-fit connection of two foundation elements according to FIGS. 6C and 6D,

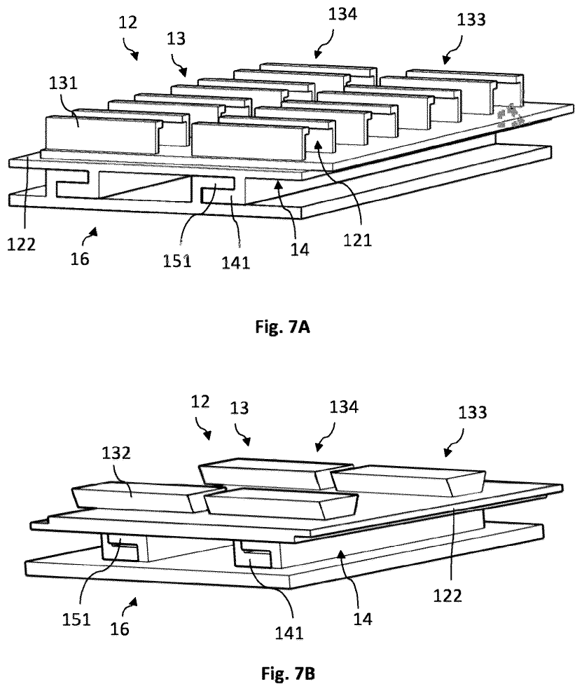

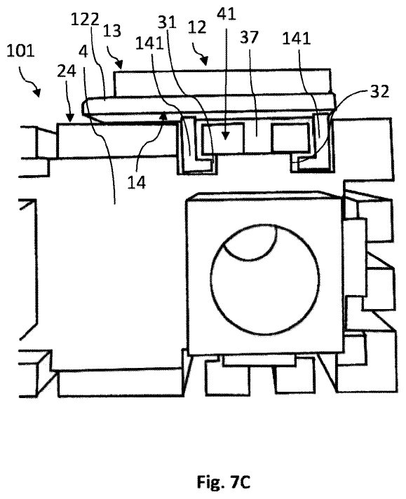

FIGS. 7A and 7B: Perspective view of a first and a second embodiment of the wall panel connected to a first and a second embodiment of a casing element,

FIG. 7C: Perspective top view of a component with a third embodiment of a wall panel attached so that a recess in the center remains free,

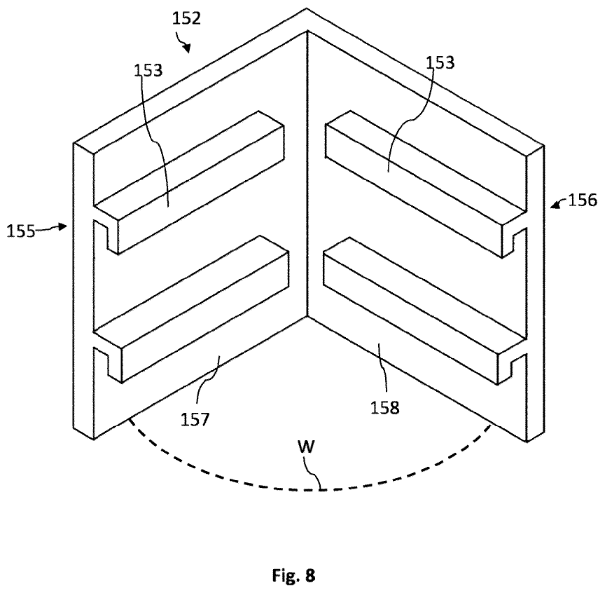

FIG. 8: Perspective view of a first embodiment of a corner casing element,

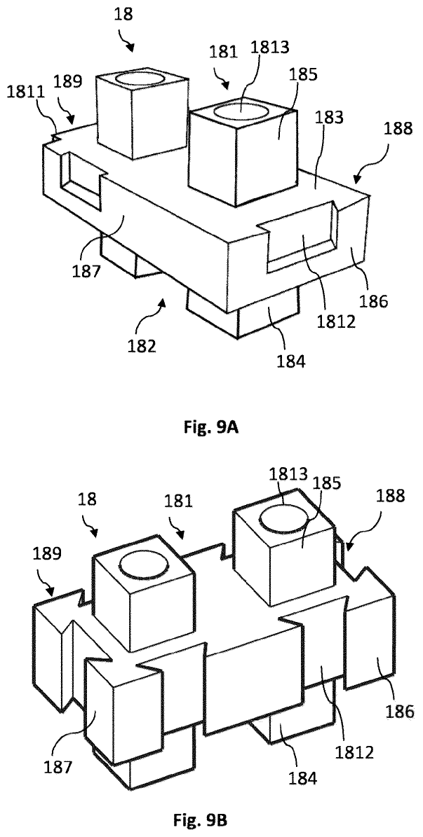

FIGS. 9A and 9B: Perspective view of a first and second embodiment of a base element for the connection between a component and a foundation element,

FIGS. 10A and 10B: Perspective view of a third and fourth embodiment of a base element for the connection between a floor covering element/component and a foundation element,

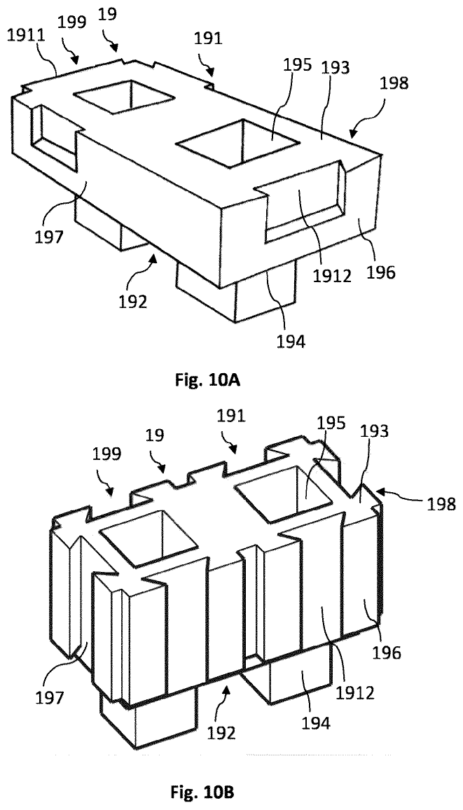

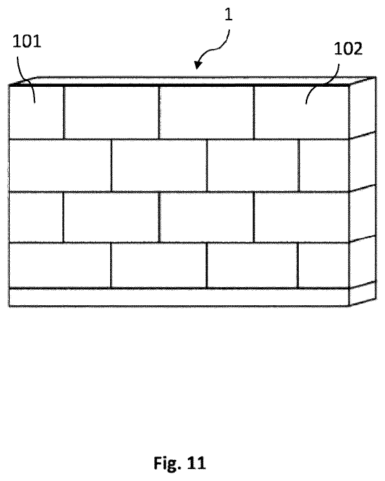

FIG. 11: Schematic, perspective view of a system with box-shaped components arranged one above the other,

FIGS. 12A and 12B: Perspective view of a first and second embodiment of a system comprising a component, a foundation element, a base element, a connecting element, a wall panel, and a casing element,

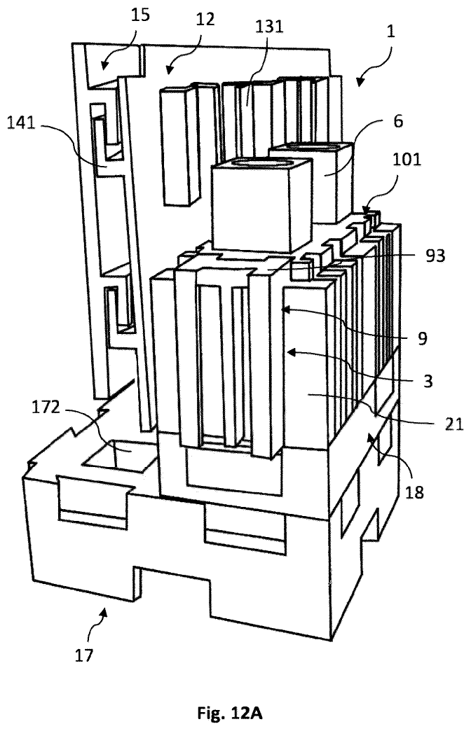

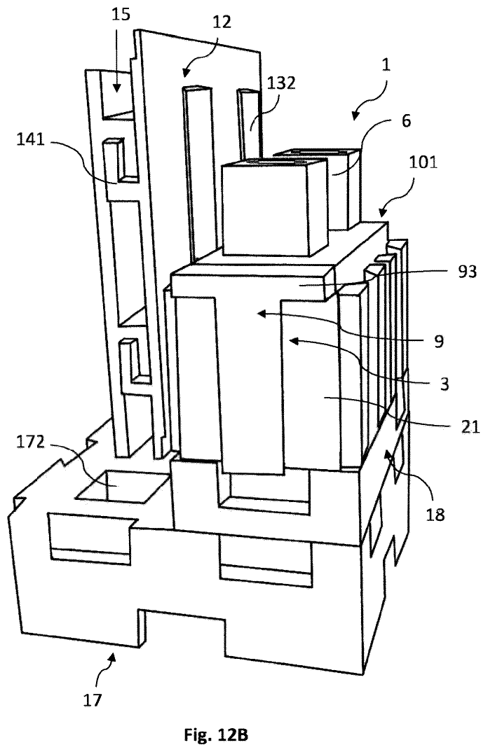

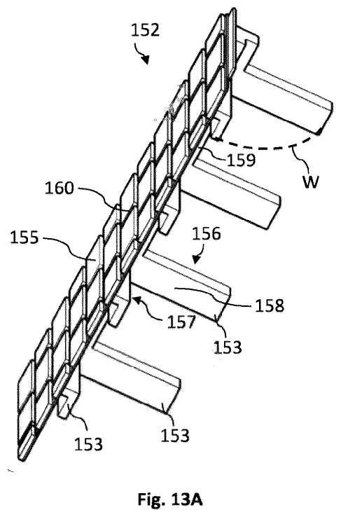

FIGS. 13A to 13C: Perspective views of a second and third embodiment of a corner casing element,

FIGS. 14A and 14B: Perspective views of two further alternative embodiments of a component,

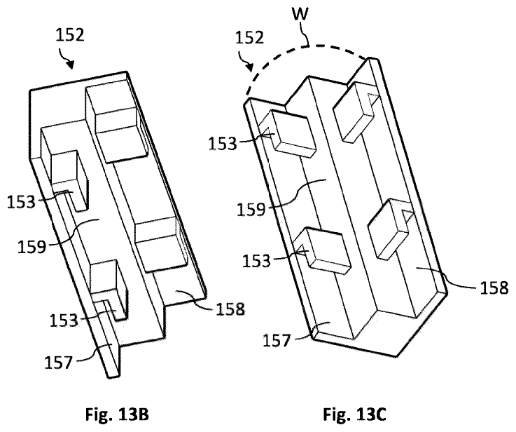

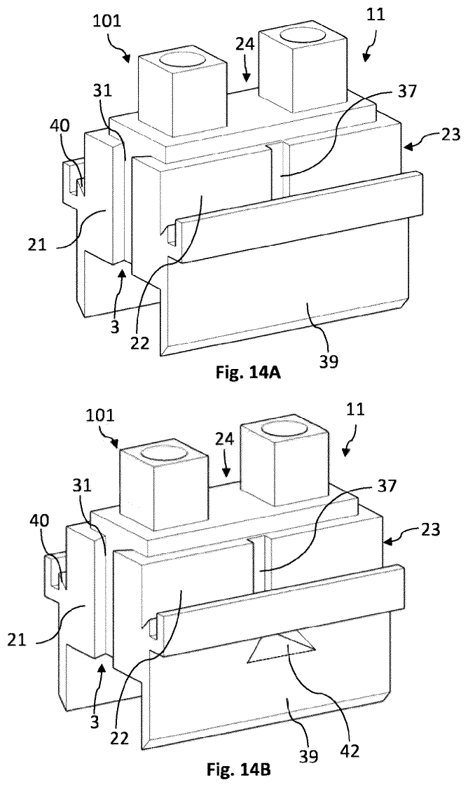

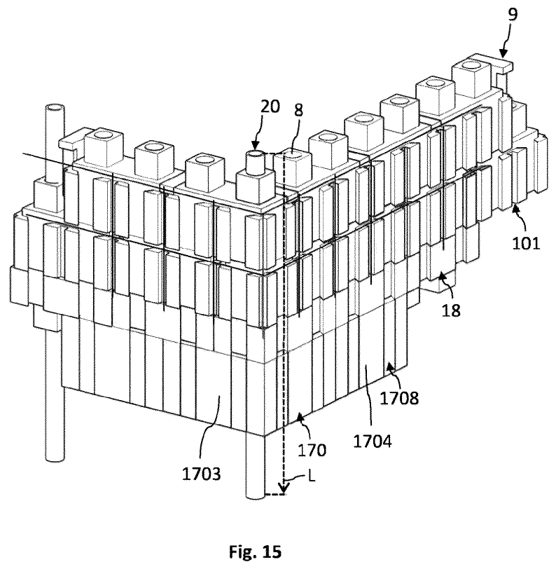

FIG. 15: Perspective view of a wall formed by a plurality of components, connecting elements for connecting the components, base elements, foundation elements with locking elements and reinforcements.

FIGS. 1A and 1B show perspective views of an embodiment of a component 101 from below and from above. The component 101 has two female connecting elements 7 on the lower side 5 and two male connecting elements 6 on the upper side 4, which are arranged one above the other in an installation position 11 essentially on a vertical axis V. In addition, the male and female connecting elements 6, 7 are arranged centrally between two opposite side faces 22, 24. The component 101 in the installation position 11 is twice as wide as it is deep and the connecting elements 6, 7 are arranged exactly in the center of one half of the component 101 with a square base. The width B of the component 101 is 40 cm, the height is 20 cm and the depth D is also 20 cm. The height of the component 101 in the installation position 11, including the male connecting element 6, is 30 cm.

A passage 8 extends through the upper male connecting element 6 in a vertical direction and merges into the opening of the female connecting element 7 on the lower side 5. The female connecting element 7 and male connecting element 6 are box-shaped, so that the male connecting element 6 of the component 101 can be inserted into the female connecting element 7 of a component 101 located above it in a form-fitting and rotationally secure manner. One receiving structure 3 is arranged on each of the two lateral side faces 21, 23 and two receiving structures 3 are arranged on each of the end-face oriented side faces 22, 24. A receiving structure 3 comprises two recesses 31, 32 between which a recess 37 is arranged. The longitudinal axes of the recesses 31, 32 and the recess 37 run parallel to each other in the vertical direction of the component 101 in the installation position 11 and extend over the entire side faces 21, 22, 23, 24. The cross-section of the recesses 31, 32 is the same along the entire vertical axis and has an undercut (see FIGS. 3A to 3H). The recess 37, on the other hand, has a substantially constant rectangular cross-sectional shape along its entire longitudinal axis.

The upper side 4 of the component 101 has a step 41 extending circumferentially along the edge between the upper side 4 and the side faces 21, 22, 23, 24. The step 41 forms a partially enclosed box-shaped cavity when two components 101 are arranged on top of each other. The step 41 connects the recesses 31, 32 and recesses 37 of the receiving structure 3 with each other. Thus, the step 41 can be used for laying, in particular in a horizontal direction in the installation position 11, electrical or water pipes.

FIGS. 2A to 2C show three alternative embodiments of a cube-shaped component 102 in a perspective view. A cube-shaped form of the components 102 allows, in combination with components of double width (see FIG. 1A and FIG. 1B), the components to be arranged one above the other in rows offset relative to each other (see FIG. 11). The component in FIG. 2A has a hollow cylindrical male connecting element 61, so that several components 102 can be arranged one above the other in a rotatably connected manner. In contrast, the components 102 in

FIG. 2B and FIG. 2C have a prism-shaped male connecting element 62. In FIG. 2B, the male connecting element 62 has a hexagonal base and in FIG. 2C a square base. The components 102 according to FIG. 2B and FIG. 2C can thus be connected in a non-rotatable manner on the upper side 4 and lower side 5 to other components 102 in an installation position 101. The longitudinal axis of a passage 8 is aligned exactly centrally in the component 102 and runs in the vertical direction V in the installation position 11. The same receiving structure 3 is arranged on all side faces 21, 22, 23, 24, so that no errors in the alignment of the components 102 can occur when the components 102 are arranged. Each receiving structure 3 in FIG. 2A and FIG. 2B comprises two recesses 31, 32 and a depression 37. In contrast, the receiving structure 3 of the component 102 of FIG. 2C has only one recess 31, which has a trapezoidal base, so that a dovetail-shaped attachment element can be attached (see FIGS. 4C and 4D). In addition, the recess 37 in FIG. 2C runs from the upper side 4 to the lower side 5 in the area of two adjacent side faces 21, 22, 23, 24 and has a cross-sectional area of 2 cm×2 cm.

The width B of the component 102 in FIGS. 2A to 2C is 20 cm, the height is 20 cm and the depth D is also 20 cm. A height of the component 102 in the installation position 11 including the male connecting element 61, 62 is 30 cm.

FIG. 2D shows a perspective view of a fourth embodiment of the component 101 connected to an attachment element 9 of FIGS. 4C and 4D in a receiving structure 3 of the component 101. For components of the component 101 described above, reference is made to FIG. 2C. The component 101 in FIG. 2D has twice the width of the component in FIGS. 2A to 2C, 40 cm. On the two long sides 22, 24 of the component 101 two receiving structures 3 are attached next to each other and on the shorter sides 21, 23 one receiving structure 3 each. In the receiving structure 3 of the right short side 23 an attachment element 9 is attached. The attachment element 9 is essentially T-shaped and has a connecting bar 311 with two lateral, dovetail-shaped widenings 3111 (see FIGS. 4C and 4D). By inserting the connecting bar 311 into the two recesses 31 with a trapezoidal base of adjacent components 101, the components 101 can be connected to each other. Half of a head region 93 of the attachment element 9 is arranged in a respective step 41 of the components. However, the shape of the head region 93 of the attachment element 9 leaves the step 41 of the adjacent side faces 22, 24 free. Thus, for example, a cable can be routed horizontally to the side faces 22, 24 within the step.

FIGS. 3A to 3H show cross-sections of various embodiments of recesses 32 of a component, such as according to FIG. 1A to FIG. 2B. All recesses 32 have an undercut 33 with a larger extent 35 than the extent 36 in an opening area 33. The cross-section can be L-shaped as in FIG. 3A or T-shaped as in FIG. 3B. In addition, the cross-section can include rounded areas as in FIG. 3C to FIG. 3F, so that the pressure of inserted attachment elements, in particular connecting latches, can be distributed more evenly and no load peaks of the material occur. The recess 32 in FIG. 3G and FIG. 3H is dovetail-shaped. In all embodiments FIG. 3A to FIG. 3H, an attachment element can be inserted in a substantially form-fitting manner in the longitudinal direction of the recess 32. For this purpose, two recesses 32 of two adjacent components are arranged in such a way that the side faces 22 abut against each other and the recesses 32 form a connected cavity. Subsequently, the components can be fixed relative to each other by inserting the attachment element into the cavity formed in the recesses 32.

FIGS. 4A and 4B show perspective views of a first embodiment of an attachment element 9 from below and from above. In an installation position 95, the attachment element 9 has a head region 93 which comprises lateral flanges 941, 942 which have a wider extension 96 than a central web 92 of the head region 93. The head region 93 of the attachment element 9 thus forms a double-T profile 91 in a horizontal plane in an installation position 95. Such a double-T profile 91 allows the attachment element 9 to be inserted into a step on the upper side of a component in a substantially form-fitting manner (see FIG. 5A and FIG. 5B), so that the step prevents the attachment element 9 from tilting relative to the component.

In the installation position 95 in the laterally outer region of the flanges 941, 942, the head region 93 is materially connected to a first connecting latch 311 and a second connecting latch 321. A center bar 371 for connecting the recesses is arranged between the first connecting bar 311 and the second connecting bar 321. The connecting bars 311, 321, 371 run parallel and are not connected to one another on the side opposite the head region 93. Thus, the connecting latches 311, 321, 371 can be inserted together from above into the recesses of two adjacent components in the installation position 95 by a single translational movement. FIG. 4A also shows that the first and second connecting latches 311, 321 are c-shaped in cross-section and the open sides 312, 322 of the c-shaped connecting latches 311, 321 are aligned with each other. Such an inwardly directed shape 312, 322 of the recesses 311, 321 allows the recesses 311, 321 to be placed laterally far apart, so that the fixation with an attachment element 9 can be improved. Two C-shaped connecting bars 311, 321 make the connection of the components more flexible. Even if the connecting latches 311, 321 are damaged/defective, a connection can still be ensured by the other connecting latch 311, 321 of two components.

FIGS. 4C and 4D show perspective views of a second embodiment of an attachment element 9 from below and from above. In an installation position 95, the attachment element 9 has a head region 93 which has a constant extension 96. The attachment element 9 also has a central connecting bar 311. The connecting bar 311 has two opposing dovetail-shaped widenings 3111 on each of the lateral side faces 98, 99. The connecting latch 311 of the attachment element 9 can fix the two components relative to each other by a translational movement into the recesses of two adjacent components with trapezoidal recesses (FIG. 2C or FIG. 2D). The connecting bar 311 has a substantially congruent shape to the trapezoidal recesses with undercut of the components. Such a dovetail-shaped connecting bar 311 makes the connection of two components more stable and rigid.

FIG. 5A shows a perspective view of an embodiment of a component 102 with a step 41 highlighted by a dotted area. In an installation position 11 of the component, the step 41 extends from an upper end of a first recess 31 via the upper end of a recess 37 to the upper end of a second recess 32 of the receiving structure 3. All side faces 21, 22, 23, 24 have identical receiving structures 3 with recesses 31, 32 and the recess 37, at the upper end of which the step 41 of the upper side 4 is arranged in an installation position 11.

FIG. 5B shows a perspective view of an embodiment of the component 102 according to FIG. 5A with an attachment element 9 inserted into the receiving structure 3 in longitudinal section LS (see FIG. 4B). The longitudinal section LS runs exactly centrally through the attachment element 9 parallel to the side face 22. One half of a head region 93 of the attachment element 9 with a double-T profile 91 is marked with dots in FIG. 5B for better visibility. The head portion 93 of the attachment element 9 positively fills the step between a side 22 and the upper side 4 of the component (see FIG. 5A). The attachment element 9 also has connecting latches 311, 321, 371, which are also positively fixed in the recesses 321, 322 and a recess 37. The recesses 32, 32 and the recess 37 are arranged adjacent to the recesses 32, 32 and the recess 37 of the connected component 102 in the connected state of two components 102. The height H, width B, and depth D have the same dimensions as in FIGS. 2A and 2B.

FIGS. 6A and 6B show a foundation element 17 in a perspective view from below and from above. The foundation element 17 has a cavity 179 on a lower side 1712, which is suitable for receiving fillers such as cement or reinforcement such as steel struts. In addition, the cavity 179 of the foundation element 17 is suitable for accommodating pipes, in particular water pipes of an underfloor heating system. The cavity 179 has an opening 1791 to all side faces 173, 174, 175, 176 of the foundation element 17. The openings 1791 are arranged centrally on the side faces 173, 174, 175, 176 so that the cavities 179 of adjacent foundation elements 17 can be connected to one another. On the upper side 1711, the foundation element 17 also has a passage 1792, which is connected to the cavity 179. Thus, the foundation element 17 can be filled from above, for example with cement through the passage 1792 after proper attachment.

In an alternative embodiment, the cavity 179 can also be closed at the bottom in an installation position 171 of the foundation element. In addition, the foundation element 17 has female connecting elements 178 or male connecting elements 177 on the edges of the upper side 1711 and the side faces 173, 174, 175, 176.

In FIG. 6A and FIG. 6B, a pair of male or female connecting elements 177, 178 are each arranged on a side face 173, 174, 175, 176. The male and female connecting elements 177, 178 extend from the upper side only over a partial area of the side faces 173, 174, 175, 176 and not completely to the lower side 1712. Thus, adjacent foundation elements 17 in the installation position 171 can be connected to each other by the complementary female and male connecting elements 177, 178 even by slightly lifting one of the foundation elements 17. The upper side 1711 also has four recessed receiving regions 172 so that a base element can be attached for connection to a floor covering element or component (see FIGS. 9 and 10). The recessed receiving regions 172 are arranged on the foundation element 172 in such a way that the receiving regions 172 of several connected foundation elements 17 are equidistant from one another. Thus, for example, components (see FIGS. 1A and 1B) can be attached to two receiving regions on one foundation element 17 or to two adjacent foundation elements 17. The foundation element 17 has a height of 30 cm, a depth of 40 cm and a width of 40 cm. Such a size provides an ideal weight for attaching the foundation elements 17, as they are easy to lift and still cover a large area. The base area in FIGS. 6A and 6B is thus exactly twice as large as the base area of a component in FIGS. 1A, 1B or 2D. Due to the large cavity 179, the foundation elements 17 are nevertheless easy to lift in order to be placed.

FIGS. 6C and 6D show a perspective view from below and from above of an embodiment of the foundation element 170. The foundation element 170 has four side faces 1703, 1704, 1705, 1706, each of which has two undercuts 1707. The undercuts 1707 extend vertically in an installation position 1701 (see FIG. 6D) from an upper side 17011 to a lower side 17012 of the foundation element 170. The foundation element 170 also has four receiving regions 1702 on the upper side 17011, which can be connected to a base element 18 (see FIGS. 9A-10B). The receiving regions 1702 can also alternatively form passages for receiving reinforcements 20 (see FIG. 15).

FIG. 6C shows that the foundation element 170 forms an open cavity 1709 on the lower side 17012, each of which is connected to lateral openings that are partially formed by the undercuts 1707. Thus, the cavity 1709 can be connected to adjacent cavities of other foundation elements 170 so that, for example, a foundation of fillers such as cement can be poured. The foundation element 170 also has a passage 1710 on the upper side 17011, so that the foundation element 170 can be filled from above in the installation position 1701.

To prevent the fillers from escaping, for example at the edge of the planned foundation, a closing element 1708 can close the lateral opening in the form of the undercut (see FIG. 6C). Neighboring foundation connecting elements 170 can also be connected with a foundation connecting element 90, which can be positively inserted into the undercuts 1707 of neighboring foundation connecting elements 170 (see FIG. 6F).

FIG. 6E shows a perspective view of an embodiment of a closure element 1708 for closing a lateral opening of an embodiment of the foundation element 170 according to FIGS. 6C and 6D. A cross-sectional area of the closure element 1708 is essentially isosceles trapezoidal and is constant over an entire longitudinal extent L of the closure element 1708. This enables the closure element 1708 to be easily inserted into the undercut 1707 (see FIGS. 6C and 6D) in order to close the cavity 1709 located behind it, so that no filler can escape during filling.

FIG. 6F shows a perspective view of an embodiment of a foundation connecting element 90 for positively connecting two foundation elements 170 according to FIGS. 6C and 6D. A cross-sectional area of the foundation connecting element 90 is constant along a longitudinal extension L of the foundation connecting element 90. The cross-sectional area is formed by two isosceles trapezoids, which are connected to each other at their short side (see dashed line). In addition, the foundation connecting element 90 has a projection 100 in an upper region in an installation position, which is formed to correspond to a recess in the foundation connecting element 170 (see FIGS. 6C and 6D).

FIGS. 7A and 7B show two perspective views of a first and a second embodiment of a wall panel 12, which is connected to a casing element 15. The wall panel 12 in FIG. 7A has a plurality of first L-shaped connection areas 131 on a first side face 13. The open sides of the L-shaped connection areas 131 face each other in pairs, so that an intermediate space 121 is partially enclosed. On each of the first side faces 13, three such L-shaped connection areas 131 are arranged in pairs in two adjacent rows 133, 134.

Second L-shaped connection areas 141 are arranged on an opposite second side face 14 of the wall panel 12 in FIG. 7A and FIG. 7B. The second L-shaped connection areas 141 extend over a large part (see FIG. 7B) or the entire second side face 14 (see FIG. 7A) and run orthogonally to the first connection areas 131. In an installation position of the wall panel 12, the first connection areas 131 are oriented with their longitudinal axis vertical and the second connection areas 141 are oriented with their longitudinal axis horizontal. The wall panel 12 also has a plurality of stepped regions 122, so that adjacent wall panels 12 contact each other in a larger area and thus seal and insulate better. A separate seal on the step-shaped areas 122 would also be conceivable.

The first L-shaped connection areas 131 can be positively inserted into the recesses 31, 32 with an undercut of the receiving structure 3 of the component (see FIGS. 1A and 1B) in order to be connected to a side face of the component. The recesses of components arranged one above the other are connected to each other at the sides, so that the wall panel 12 with the first connection area 131 can be inserted along the recesses of several components in an installation position from above.

A first row 133 of the connection areas 131 of the wall panel 12 can thereby be connected to a first component, and a second row 134 of the connection areas 131 of the wall panel 12 can be connected to a second component. Thus, the amount of work required to attach the wall panels can be reduced as a larger area can be attached in a single step. However, the central recess (see e.g. FIGS. 1A and 1B, 37) is left free when the wall panel according to FIG. 7A is attached, so that a cable can be routed therein (see FIG. 8).

In a second embodiment of a wall panel 12 in FIG. 7B, the first connection areas 132 are dovetail-shaped on an upper side 13. The dovetail-shaped connection areas 132 can thus be inserted into an undercut of the recess (see FIGS. 2C and 2D, 31) with a trapezoidal base surface in a substantially form-fitting manner.

On the upper side 13, two connection areas 132 are arranged next to each other in two rows 133, 134.

The second L-shaped connection areas 141 in FIGS. 7A and 7B are shaped to positively receive an L-shaped receiving region 151 of the casing element 15. For this purpose, the receiving region 151 is shaped complementary to the second connection area 141. In an installation position of the wall panel 12, an opening of the L-shaped second connection area 141 preferably points upwards, so that the receiving regions 151 of the casing element 15 can be inserted from above.

An outer side 16 of the casing element 15 is substantially aligned, so that adjacent casing elements 15 form a substantially continuous and aligned surface.

FIG. 7C shows a perspective top view of a third embodiment of a wall panel 12 attached to a component 101 according to FIGS. 1A and 1B. The wall panel 12 in FIG. 7C has an aligned first side face 13 and a second side face 14 with two L-shaped connection areas 141. The two L-shaped connecting elements 141 are substantially positively inserted into recesses 31, 32 of the component 101 from an upper side 4 of the component 101 so that the wall panel 12 is fixed to the component 101. In addition, the wall panel 12 has a stepped area 122 for increasing the contact surface to adjacent wall panels 12. However, a recess 37 of the size 2 cm×2 cm of the component 101 remains free despite the wall panel 12 being attached. Thus, an electricity or water pipe can run or be attached in the recess 37. The components 101 are shaped in such a way that the recesses 37 on a side face 24 of components 101 arranged one above the other connect to each other in an installation position in order to guide vertically running lines. In addition, the L-shaped connection areas in FIG. 7C do not extend over the entire side face 14, so that a step 41 of the component 101 remains free. This allows the cables to also be routed horizontally along the step 41 in the installation position of the component.

FIG. 8 shows a perspective view of a first embodiment of a corner casing element 152 with two connection areas 153 on each inwardly facing side face 157, 158. The connection areas 153 are each connectable to the L-shaped connection areas of the wall panels (see FIGS. 7A, 141) with two side faces of a component arranged next to each other and orthogonally. The connection areas 153 run horizontally so that the L-shaped opening can be aligned downwards. Thus, the corner casing element 152 can be inserted vertically from above into the connection areas of the wall panel. Such a corner casing element 152 has two flat surfaces, which are formed by two outer surfaces 155, 156 of the corner casing element 152. In FIG. 8, the outer surfaces 155, 156 form an angle of 270° to each other. The inner surfaces 157, 158, on the other hand, form an angle W of 90° to each other in FIG. 8. Thus, the corner casing element 152 can be attached to an outer corner with adjacent sides at 270° to each other of a component system.

Analogous to this embodiment of the corner casing element 152, in a second embodiment the connection areas 153 can also be arranged on the outer surfaces 155, 156 to form a corner by two aligned inner surfaces 157, 158 of 90 degrees (not shown in the figures). Thus, the corner casing element can be attached to an inner corner with adjacent sides at 90 degrees to each other.

FIGS. 9A and 9B show a perspective view of a first and second embodiment of a base element 18 for connection between a component 101 (see FIGS. 1A and 1B or FIGS. 2C and 2D) and a foundation element 17, 170 (see FIGS. 6A to 6D). The base element 18 has a protruding box-shaped region 185 on an upper side 183 in an installation position 181, which is shaped for positive connection with a female connecting element 7 (see FIG. 1A) of the component. On a lower side 182 of the base element 18 in the installation position 181, the base element 18 has two box-shaped male connecting elements 184. The male connecting elements 184 are shaped complementary to the recessed areas 172, 1702 (see FIG. 6B or FIG. 6D) of a foundation element 17, 170 in FIGS. 6A-6D. In addition, the base element 18 in FIGS. 9A and 9B has dovetail-shaped connecting elements 1811, 1812 on all four side faces 186, 187, 188, 189.

FIG. 9A shows that a female dovetail-shaped connecting element 1812 is arranged on each of the two front side faces 186, 187 and a male dovetail-shaped connecting element 1811 is arranged on each of the rear side faces 188, 189. Thus, horizontally adjacent base elements 18 can be connected to each other by the dovetail-shaped connecting elements 1811, 1812 in FIG. 9A.

FIG. 9B shows that a female dovetail-shaped connecting element 1812 is disposed on each of the side faces 186, 187, 188, 189. The female connecting elements 1812 can be connected to each other by base connecting elements, which are shaped similarly to the foundation connecting elements 90 (see FIG. 6F).

In addition, the base element 18 in FIGS. 9A and 9B has a passage 1813 which, when properly installed, is adjacent to the passage (see, for example, FIGS. 1B, 8) of the components.

FIGS. 10A and 10B show a perspective view of a third and fourth embodiment of a base element 19 for connecting a floor covering element, in particular parquet flooring, and a foundation element (see FIGS. 6A and 6B). In contrast to FIGS. 9A and 9B, the base element 19 has a connecting element 194 on an upper side 193 in the form of a recessed box-shaped region 194. The recessed area 195 is shaped in a complementary manner for receiving a floor covering element (not shown in the figures).

The recessed region 195 may also be shaped complementary to receive a male connecting element 6 of the component (see FIGS. 1A and 1B).

The dovetail-shaped connecting elements 1911, 1912 in FIG. 10A on the side faces 196, 197, 198, 199 of the base element 19 and the male connecting element 194 are shaped analogously to FIG. 9A.

The dovetail-shaped connecting elements 1912 in FIG. 10B on the side faces 196, 197, 198, 199 of the base element 19 and the male connecting element 194 are shaped analogously to FIG. 9B.

A base area of the base element 18, 19 in FIG. 9A to FIG. 10B is 40 cm×20 cm, so that two base elements 18, 19 can be arranged on the foundation element to cover it completely.

FIG. 11 shows a schematic, perspective view of a system 1 with several components 101, 102 that are partially offset from each other in order to increase stability. The stability can also be further increased, for example by passing steel struts through adjacent passages 8 (see FIGS. 1A and 1B) through several components 101, 102 arranged one above the other. For better clarity, the receiving structures 3 and connecting elements 6, 7 (see FIGS. 1A and 1B) of the components 101, 102 are not shown in FIG. 11.

The system 1 in FIG. 11 comprises both essentially box-shaped components 102 with a base area of 20 cm×20 cm and box-shaped components 102 with a base area of 20 cm×40 cm. The height of the components 101, 102 is 30 cm.

FIGS. 12A and 12B show a perspective view of a first and second embodiment of a system 1 comprising a construction element 101, a foundation element 17, a base element 18, a connecting element 9, a wall panel 12, and a casing element 15. On a half base surface of the foundation element 17, the base element 18 is fixed by two male connecting elements 184 (see FIG. 10) on the lower side in recessed and box-shaped areas 172 of the foundation element 17. On the upper side of the base element 18, the base element 18 is connected to the female connecting elements 7 (see FIG. 1A) by inserted box-shaped areas 185 (see FIG. 10). The base element 18 and the component 101 have the same base area of 40 cm×20 cm.

On a front side 21 of the component 101 in FIGS. 12A and 12B, an attachment element 9 is half recessed in a receiving structure 3 of the component 101, so that the head portion 93 (see FIGS. 4A-4C) fills a step 41 (see FIG. 1B) of the component 101 on the front side 21. In FIG. 12A, the component 101 has a double L-shaped receiving structure according to FIGS. 2A and 2B and in

FIG. 12B a partially dovetail-shaped receiving structure according to FIGS. 2C and 2D. In FIG. 12A, the attachment element 9 has two lateral connecting latches 311, 321 and a central latch 371 (see FIGS. 4A and 4B), analogous to FIGS. 4A and 4B. In FIG. 12B, on the other hand, the attachment element 9 has a dovetail-shaped central connecting bar 311 (see FIGS. 4C and 4D). The wall panel in FIG. 12A has two double L-shaped first connection areas 131, shaped complementary to the receiving structure 3 of the component 101, analogous to FIG. 7A. In FIG. 12B, on the other hand, the first connection areas 131 are dovetail-shaped and complementary to the receiving structure 3, analogous to FIG. 7B.

In FIGS. 12A and 12B, the casing elements 15 are inserted into the upwardly open second L-shaped connection areas 141 to secure the casing elements 15 to the wall panel 12. In FIGS. 12A and 12B, the wall panels 12 are twice as high as the component 101 without a male connecting element 6 of the component 101. Such wall panels 12 achieve an optimum weight of the wall panels 12 and also reduce the labor required for attaching them to the components 101. Since the receiving structure 3 of the components 101 extends vertically upwards in the installation position, several receiving structures 3 can be connected to each other so that the wall panel 12 can be easily attached.

FIGS. 13A to 13 C show a second and a third embodiment of a corner casing element 152 with two adjacent connection areas 153 at an angle to each other. In the second embodiment of the corner casing element 152 in FIG. 13A, the connection areas 153 are arranged in four rows one above the other on the inwardly facing side faces 157, 158. In the third embodiment of the corner casing element 152 in FIG. 13B and FIG. 13C, the connection areas 153 are arranged in only two rows one above the other on the inwardly facing side faces 157, 158. The connection areas 153 can each be connected to the connection areas 141 of the wall panels (see FIG. 7A) or directly to a component (see FIG. 14). Analogous to FIG. 8, the connection areas 153 have L-shaped openings which can be aligned vertically downwards in an operating position in order to be connected to the wall panels and/or components. The adjacent connection areas 153 of the corner casing element 152 are arranged at an angle W of 90° to each other. However, an analogous embodiment of 270° would also be conceivable for shuttering internal corners. By such an embodiment, the corner casing element 152 can be attached to an inner corner of a wall with adjacent sides at 90° to each other.

The corner casing element 152 in FIG. 13A has four connection areas 153 arranged one above the other and the corner casing element 152 in FIG. 13B and FIG. 13C has two connection areas 153 arranged one above the other, so that the corner casing element can be connected to a plurality of wall panels or components at the same time. For this purpose, the four connection areas 153 are rigidly connected to each other by an elongated support 159. In this way, the amount of work required to attach the corner casing element 153 can be reduced and, in addition, a casing that is as flat as possible can be achieved.

For better visibility of the connection areas 153, an exemplary structured shuttering 160 has been shown in FIG. 13A on only one outer side 155. However, this casing 160 is attached to the corner casing element 152 on both outer sides 155 and 156 and is rigidly connected thereto.

FIGS. 14A and 14B show perspective views of two further alternative embodiments of a component 101 in an installation position 11. The component 101 differs from the component in FIGS. 1A and 1B by dovetail-shaped receiving structures 3 with only one recess 31 on each of the two end faces 21, 23. In addition, the component 101 in FIG. 14A and FIG. 14B has upwardly open L-shaped receiving structures 38 on the two lateral side faces 22, 24. These L-shaped openings of the receiving structures 38 run horizontally in the installation position 11 and extend over an entire longitudinal length of the component 101. A casing element 16 (see FIGS. 7A and 7B) can be attached directly in these receiving structures 38 without requiring a wall panel 12 (see FIG. 7A). In addition, these receiving structures 38 also have a vertically extending recess 37 with a rectangular cross-sectional area for guiding cables. A further difference between the embodiment of the component 101 in FIG. 14A and FIG. 14B and FIGS. 1A and 1B is that the component 101 has a downwardly protruding projection 39 on each of the lateral side faces 22, 24 and a receptacle 40 for this projection 39. This projection 39 extends over the entire longitudinal length of the component 101. The projection 39 is adapted to substantially positively enclose an underlying side face 22, 24 of another component 101 and to be inserted into the receptacle 40. By means of the attachment 39 and the receptacle 40, a more stable mounting of components 101 arranged one above the other can be achieved. A renewed description of the previously described features (see FIG. 1A, FIG. 1B, FIG. 5A and FIG. 5B) has been omitted in FIGS. 14A and 14B.

The embodiment of the component 101 in the installation position 11 in FIG. 14B differs from the embodiment in FIG. 14A by a horizontal recess 42, which is arranged on a lateral side face 22 and extends partially through the component 101. This recess 42 is adapted to receive a steel beam as a supporting device for an intermediate floor. Thus, by such components 101 having horizontal recesses 42 on opposite wall portions, steel beams can be received so that a false floor can be supported by steel beams.

FIG. 15 shows a perspective view of a wall formed by a plurality of components 101 (see FIG. 2D), connecting elements 9 for connecting the components 101, base elements 18 (see FIGS. 9A-9B), foundation elements 170 (see FIGS. 6C and 6D) with closure elements 1708 (see FIG. 6E) and elongated reinforcements 20.

The side faces 1703, 1704 of the foundation element 170 are sealed by a plurality of closure elements 1708 so that the adjacent cavities 1709 can be filled with filler material through the passages 1710 (see FIGS. 6C and 6D).

In contrast to FIGS. 6C and 6D, the foundation element 170 also has passages in the receiving regions 1702 so that the reinforcement 20 can be guided through the receiving elements.

The elongated reinforcement 20 is formed by a PVC or steel pipe, which can be passed through the adjacent passages of the component 101, base element 18 and foundation element 170. This enables the reinforcement to be anchored in the ground and/or the foundation which can be cast using filler material.

1-18. (canceled)

19. A box-shaped component comprising at least partly plastic and
four side faces which are aligned vertically in an installation position of the box-shaped component and
each have at least one receiving structure for receiving at least one attachment element, wherein
an upper side of the box-shaped component in the installation position has a male connecting element and a lower side has a female connecting element, or
the upper side has a female connecting element and the lower side has a male connecting element,
wherein the male connecting element and female connecting element are shaped complementary to each other.

20. The box-shaped component according to claim 19, wherein the at least one receiving structure extends continuously in a straight line from an upper side of the component to a lower side of the component.

21. The box-shaped component according to claim 19, wherein the receiving structure comprises at least one recess extending over a part or the entire side face, wherein a cross-section of the recess comprises an undercut, and the cross-section of the recess is L-shaped or dovetail-shaped.

22. The box-shaped component according to claim 21, wherein the receiving structure has at least two recesses and the longitudinal axes of the recesses run parallel and spatially spaced from one another.

23. The box-shaped component according to claim 19, wherein the upper side comprises a step between at least one of the side faces and the upper side, so that box-shaped components arranged one above the other form an at least partially enclosed cavity which is adjacent to a recess.

24. The box-shaped component according to claim 19, wherein the box-shaped component comprises a passage having a longitudinal axis extending in a straight line from the upper side to the lower side.

25. The box-shaped component according to claim 19, wherein, in the installation position of the box-shaped component, the box-shaped component
has a height H, measured in the vertical direction, in the range from 10 cm to 40 cm;
a width W, measured from the farthest side faces, in the range from 10 cm to 80 cm;
a depth D, measured in a direction perpendicular to the height and width, in the range from 10 cm to 40 cm.

26. A method of manufacturing a box-shaped component according to claim 19, wherein the box-shaped component is manufactured by injection moulding.

27. A system comprising at least two components according to claim 19 and an attachment element for positive connection to a receiving structure of one of the components and for connecting two receiving structures of the components.

28. The system according to claim 27, wherein the system comprises at least one first box-shaped component and at least one second box-shaped component, wherein the first box-shaped component is half as large, one third as large, or one quarter as large as the second box-shaped component.

29. The system according to claim 27, wherein the system comprises a wall panel, and the wall panel has a first connection area on a first side face, which protrudes from the side face and can be positively connected to a receiving structure of the box-shaped component.

30. The system according to claim 29, wherein the system comprises a separate casing element, wherein the wall panel has a second connection area (141) for attaching the casing element on a second side face opposite the first connection area.

31. The system according to claim 30, wherein the system comprises a corner casing element, wherein the corner casing element has at least one connection area, so that the corner casing element
is connectable to at least two receiving structures of adjacent side faces of a box-shaped component or
is connectable to two second connection areas of two different wall panels.

32. The system according to claim 27, wherein the system comprises a box-shaped foundation element, which has on an upper side in an installation position at least one of a recessed and/or a protruding receiving region for connection to a base element, and
has male connecting elements and female connecting elements on the four side faces, which are shaped complementary to one another.

33. The system according to claim 27, wherein the system comprises a substantially box-shaped foundation construction element which, on an upper side in an installation position, has at least one of a recessed and/or a protruding receiving region for connection to a base element or the box-shaped component, and on each of the four side faces at least one respective undercut.

34. The system according to claim 33, wherein the system comprises a closing element for closing at least one lateral opening of the foundation connecting element in the installation position, to a cavity of the foundation element and/or
a foundation connecting element for connecting two foundation elements by engaging in the undercuts.

35. The system according to claim 32, wherein the system comprises a base element which, in an installation position, has on a lower side at least one connecting element which is shaped complementary to the at least one protruding region or the recessed region of the foundation element and
has on the upper side has at least one recessed region and a horizontal surface or
has at least one protruding region on the upper side, wherein
the recessed region or the protruding region is shaped complementary to a male connecting element or a female connecting element of the box-shaped component.

36. A box-shaped component comprising at least partly plastic and four side faces aligned vertically in an installation position of the box-shaped component,
wherein at least two side faces have a receiving structure for receiving at least one attachment element and
wherein at least one further receiving structure has a recess for receiving a cable, which extends from one side face to an opposite side face.

37. The box-shaped component according to claim 36, wherein an upper side of the box-shaped component in the installation position has a male connecting element and a lower side has a female connecting element, or
the upper side has a female connecting element and the lower side has a male connecting element,
wherein the male connecting element and female connecting element are shaped complementary to each other.

38. The box-shaped component according to claim 25, wherein, in the installation position of the box-shaped component, the box-shaped component
has a height H, measured in the vertical direction, in the range from 15 cm to 25 cm;
a width W, measured from the farthest side faces, in the range from 15 cm to 50 cm;
a depth D, measured in a direction perpendicular to the height and width, in the range from 15 cm to 25 cm.
